(19) United States
(12) Patent Application Publication
(10) Pub. No.: US 2012/0111013 A1
(43) Pub. Date: May 10, 2012

(54) SYSTEM FOR DIRECTING AIR FLOW IN A FUEL NOZZLE ASSEMBLY

(75) Inventors: Nishant Govindbhai Parsania, Bangalore (IN); Ajay Pratap Singh, Bangalore (IN)

(73) Assignee: General Electric Company, Schenectady, NY (US)

(21) Appl. No.: 12/941,808

(22) Filed: Nov. 8, 2010

(51) Int. Cl. F02C 7/22; B05B 1/28

(52) U.S. Cl. 60/737; 239/291

(57) ABSTRACT

According to various embodiments, a system includes a fuel nozzle assembly. The fuel nozzle assembly includes a hub, a shroud disposed about the hub, a flow sleeve disposed about the shroud, and an air flow path extending between the flow sleeve and the shroud in an upstream direction toward an opening region between the shroud and the hub, wherein the air flow path extends between the hub and the shroud in a downstream direction from the opening region toward an outlet region of the fuel nozzle assembly. The fuel nozzle assembly also includes a fuel flow path extending to at least one fuel port along the air flow path, and a flow guide disposed along the air flow path in the opening region, wherein the flow guide includes a first guide portion configured to guide an air flow radially outward from the hub toward the shroud.

### BACKGROUND OF THE INVENTION

The subject matter disclosed herein relates to a fuel nozzle assembly with an improved air flow design.

A gas turbine engine combusts a mixture of fuel and air to generate hot combustion gases, which in turn drive one or more turbines. In particular, the hot combustion gases force turbine blades to rotate, thereby driving a shaft to rotate one or more loads, e.g., an electrical generator. The gas turbine engine includes a fuel nozzle to inject fuel and air into a combustor. In certain combustors, the fuel nozzle receives an air flow at an upstream entrance, wherein the air flow turns from an upstream direction outside the fuel nozzle to a downstream direction inside the fuel nozzle. Unfortunately, the sharp turn at the upstream entrance causes a flow non-uniformity, which can create a low velocity or recirculation zone. In turn, the flow non-uniformity can cause non-uniform mixing of the air flow with fuel and/or a potential for flame-holding.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine fuel nozzle. The turbine fuel nozzle includes a hub, multiple vanes extending radially outward from the hub, a shroud disposed about the hub and the multiple vanes, an air flow path extending between the hub and the shroud in a downstream direction toward an outlet region of the turbine fuel nozzle, a fuel flow path extending to multiple fuel ports along the air flow path, and a converging-diverging section disposed along the air flow path upstream from the multiple vanes and the multiple fuel ports.

In a second embodiment, a system includes a fuel nozzle assembly. The fuel nozzle assembly includes a hub, a shroud disposed about the hub, a flow sleeve disposed about the shroud, and an air flow path extending between the flow sleeve and the shroud in an upstream direction toward an opening region between the shroud and the hub, wherein the air flow path extends between the hub and the shroud in a downstream direction from the opening region toward an outlet region of the fuel nozzle assembly. The fuel nozzle assembly also includes a fuel flow path extending to at least one fuel port along the air flow path, and a flow guide disposed along the air flow path in the opening region, wherein the flow guide includes a first a guide portion configured to guide an air flow radially outward from the hub toward the shroud.

In a third embodiment, a system includes a turbine engine and a fuel nozzle assembly coupled to the turbine engine. The fuel nozzle assembly includes a flow sleeve including an upstream air flow and multiple fuel nozzles disposed in the flow sleeve. Each fuel nozzle includes a downstream air flow path, and a flow guide configured to direct an air flow toward a low velocity region adjacent a turn between the upstream air flow path and the downstream air flow path.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbine system having a fuel nozzle assembly with an improved air flow design;

FIG. 2 is a cross-sectional side view of an embodiment of the turbine system, as illustrated in FIG. 1, with the fuel nozzle assembly having one or more fuel nozzles with the improved air flow design;

FIG. 3 is a cross-sectional side view of an embodiment of the fuel nozzle assembly;

FIG. 4 is a cross-sectional side view of a portion of a single fuel nozzle and surrounding region of the fuel nozzle assembly in FIG. 3;

FIG. 5 is a cross-sectional side view of an embodiment of a flow guide of the fuel nozzle of FIG. 4, illustrating a converging-diverging section;

FIG. 6 is a cross-sectional side view of an embodiment of a flow guide of the fuel nozzle of FIG. 4, illustrating a converging-diverging section;

FIG. 7 is a cross-sectional view of an embodiment of a fuel nozzle and a shroud, taken along line 7-7 of FIG. 3; and

FIG. 8 is a cross-sectional view of an embodiment of the fuel nozzle and the shroud, taken along line 7-7 of FIG. 3.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems for improving the flow of air in a fuel nozzle assembly to eliminate flow deficit regions at or near the entrances to one or more fuel nozzles, thereby reducing flow non-uniformity, pressure drops, and flame-holding. As air enters the fuel nozzle assembly, the flow of air sharply turns from an upstream direction to a downstream direction at or near the entrance to the fuel nozzle. Instead of turning sharply from the upstream direction to the downstream direction, the air flow tends to follow the path of least resistance creating a non-uniform flow or recirculation zone. The recirculation zone results in a pressure drop as well as flow deficits in one or more vane sectors downstream in a premixing passage of the fuel nozzle. The air continues to flow downstream through the premixing passage into swirl vanes which rotate the air flow. Each swirl vane contains one or more fuel ports for injecting fuel into the air flow. Upstream of the swirl vanes are regions of low velocity which may lead to flame-holding.

Embodiments of the present disclosure provide a system that includes a fuel nozzle with a flow guide (e.g., converging-diverging section) that improves flow uniformity. For example, the flow guide (e.g., converging-diverging section) is disposed along the air flow path upstream from the plurality of vanes and the plurality of fuel ports. In certain embodiments, the fuel nozzle may include a shroud (e.g., annular shroud) disposed about a hub (e.g., annular hub) to define an air flow path (e.g., annular air flow path). The flow guide and/or converging-diverging section is disposed in the air flow path at or downstream from an upstream entrance of the fuel nozzle, i.e., between the shroud and the hub. For example, the flow guide includes a first guide portion configured to guide the air flow toward a low velocity region or recirculation zone, e.g., radially outward from the hub toward the shroud. The first guide portion also may converge the air flow passage, and thus may be described as a converging section. The flow guide also may include a second guide portion downstream from the first guide portion, wherein the second guide portion may be angled away from the low velocity or recirculation zone, e.g., from the shroud toward the hub. The second guide may diverge the air flow passage, and thus may be described as a diverging section. In each of the disclosed embodiments, the flow guide substantially reduces or eliminates the flow deficit and reduces pressure drops by redirecting the air flow toward the flow deficit region, while also making the turning of the air flow smoother. The flow guide also improves flow uniformity, and provides sufficient axial velocity of the flow into each downstream vane sector to reduce the possibility of flame-holding.

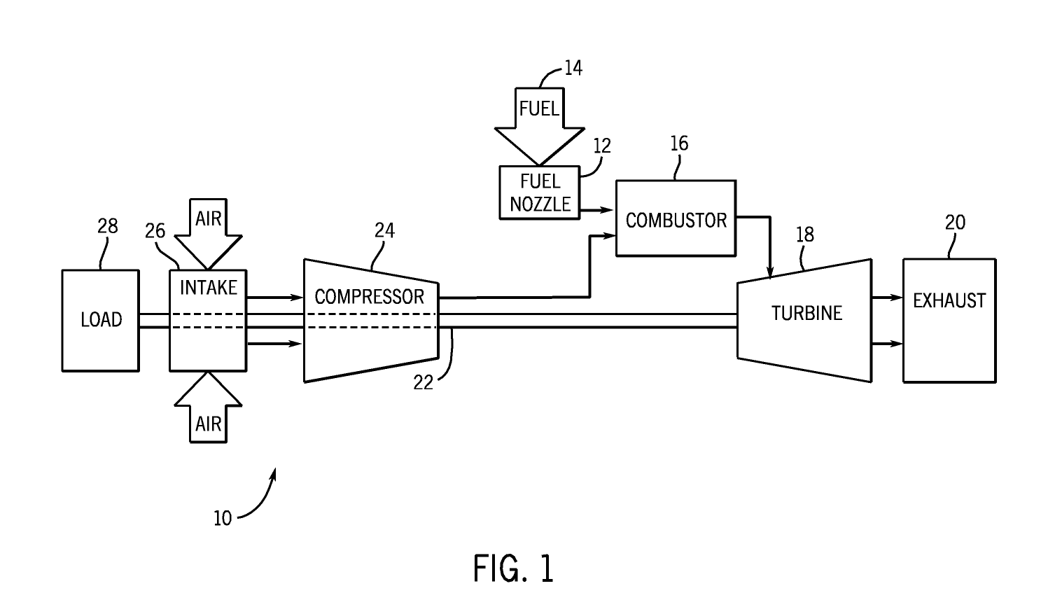

Turning now to the drawings and referring first to FIG. 1, a block diagram of an embodiment of a turbine system 10 is illustrated. As described in detail below, the disclosed turbine system 10 may employ a plurality of fuel nozzles 12 with an improved design for air flow to reduce flow deficits and flow non-uniformity in the turbine system 10. For example, each fuel nozzle 12 may include a flow guide (e.g., a converging-diverging section) configured to improve flow uniformity and reduce or eliminate recirculation zones in the fuel nozzle 12. The turbine system 10 may use liquid or gas fuel, such as natural gas and/or a hydrogen rich synthetic gas, to drive the turbine system 10. As depicted, one or more fuel nozzles 12 intake a fuel supply 14, mix the fuel with air, and distribute the air-fuel mixture into a combustor 16. The air-fuel mixture combusts in a chamber within the combustor 16, thereby creating hot pressurized exhaust gases. The combustor 16 directs the exhaust gases through a turbine 18 toward an exhaust outlet 20. As the exhaust gases pass through the turbine 18, the gases force turbine blades to rotate a shaft 22 along an axis of the turbine system 10. As illustrated, the shaft 22 may be connected to various components of the turbine system 10, including a compressor 24. The compressor 24 also includes blades coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. The load 28 may include any suitable device capable of being powered by the rotational output of turbine system 10.

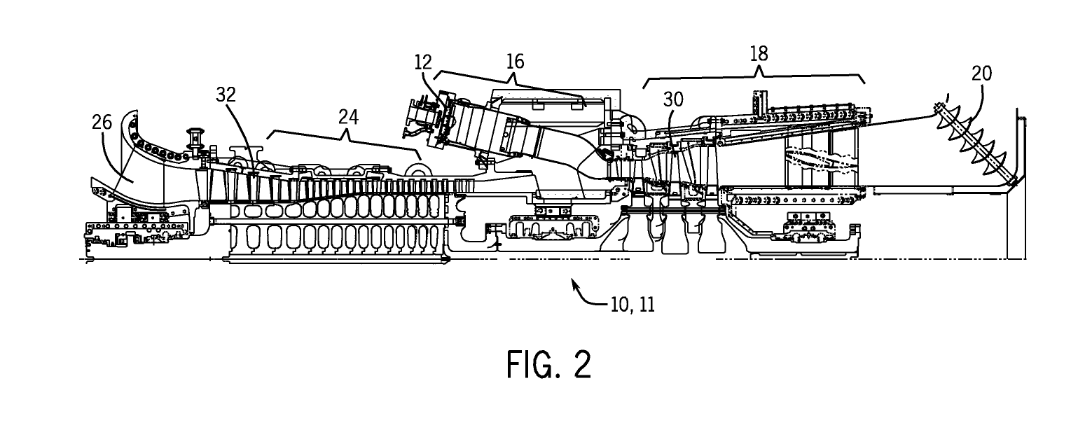

FIG. 2 is a cross-sectional side view of an embodiment of the turbine system 10 of FIG. 1, illustrating a multi-stage gas turbine engine 11. The turbine system 10 includes one or more fuel nozzles 12 located inside one or more combustors 16. As discussed below, each fuel nozzle 12 may include a flow guide (e.g., a converging-diverging section) configured to improve flow uniformity and reduce or eliminate recirculation zones in the fuel nozzle 12. In operation, air enters the turbine system 10 through the air intake 26 and is pressurized in the compressor 24. The compressed air may then be mixed with gas for combustion within the combustor 16. For example, the fuel nozzles 12 may inject a fuel-air mixture into the combustor 16 in a suitable ratio for optimal combustion, emissions, fuel consumption, and power output. The combustion generates hot pressurized exhaust gases, which then drive one or more blades 30 within the turbine 18 to rotate the shaft 22 and, thus, the compressor 24 and the load 28. The rotation of the turbine blades 30 causes a rotation of the shaft 22, thereby causing blades 32 within the compressor 24 to draw in and pressurize the air received by the intake 26.

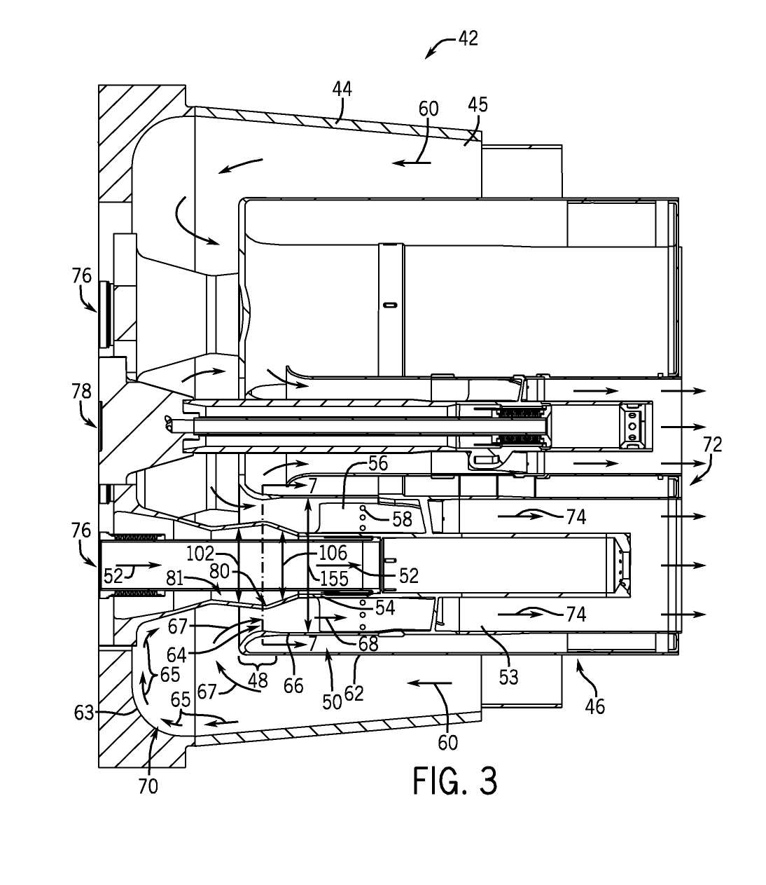

FIG. 3 is a cross-sectional side view of an embodiment of a fuel nozzle assembly 42 that may utilize an improved air flow design to eliminate the flow deficit and reduce pressure drops by redirecting the air flow toward the flow deficit region, while also making the turning of the air flow smoother. The fuel nozzle assembly 42 may be mounted in the combustor 16 of the gas turbine engine 11. The fuel nozzle assembly 42 includes a plurality of fuel nozzles 12 and an outer casing or flow sleeve 44. The fuel nozzles 12 are disposed within a cap assembly 46, which includes a front plate 48 and a plurality of shrouds. The space between the flow sleeve 44 and the cap assembly 46 defines an outer annular flow passage 45. Each shroud 50 is disposed circumferentially about a hub 54 of a respective fuel nozzle 12. The flow sleeve 44 is circumferentially disposed about the cap assembly 46 and each shroud 50. Each fuel nozzle 12 within the fuel nozzle assembly 42 includes a fuel flow path 52, the hub 54, a plurality of vanes 56 extending radially outward from the hub 54, and the shroud 50 disposed about the hub 54 and the plurality of vanes 56 (e.g., swirl vanes). Each vane 56 includes one or more fuel ports 58. The number of fuel ports 58 on each vane 56 may range from 1 to 50, 1 to 10, or any other number. For example, each vane 56 may include one or more fuel ports 58 on each side. The plurality of swirl vanes 56 disposed between the hub 54 and the shroud 50 are configured to swirl or rotate the air, while mixing fuel with air as described below.

The outer annular flow passage 45 between the flow sleeve 44 and the cap assembly 46 includes an upstream air flow path 60. In particular, the air flow path 60 extends between the flow sleeve 44 and an outer surface 62 of the shroud 50 in an upstream direction 60 toward an upstream opening region 64 disposed circumferentially about each fuel nozzle 12. For example, the illustrated opening region 64 is disposed between an inner surface 66 of the shroud 50 and the hub 54. Each fuel nozzle 12 within the fuel nozzle assembly 42 includes a downstream air flow path 68 through the inner annular flow passage 53. In particular, the air flow path 68 extends between the hub 54 and the inner surface 66 of the shroud 50. Air enters the fuel nozzle assembly 42 in the upstream direction 60. Upon passing the front plate 48, the air enters a zone 70 and turns (e.g., turning paths 65 and 67) approximately 180 degrees to flow in the downstream direction 68 through the opening region 64 between the hub 54 and shroud 50 of each fuel nozzle 12. The air then flows through the inner annular flow passage 53 between the hub 54 and the shroud 50 toward an outlet region 72 of the fuel nozzle assembly 42. Upon entering the opening regions 64 of the fuel nozzles 12, the air flows downstream to the plurality of vanes 56 to mix with fuel (e.g., fuel ports 58 in vanes 56) along the air flow path 68. A resultant air-fuel mixture 74 is directed toward the outlet region 72 of the fuel nozzle assembly 42 for combustion.

Each fuel nozzle 12 may include any number of vanes 56. For example, each fuel nozzle 12 may include 1 to 20 or 2 to 10 vanes 56, or any number therebetween. Circumferentially about each fuel nozzle 12, the vanes 56 divide the inner annular flow passage 53 into multiple sectors to swirl the air flow and induce mixing of the air with fuel. For example, 10 vanes 56 evenly disposed about the circumference of the fuel nozzle 12 may result in 10 sectors of about 36 degrees each. Air flow entering zone 70 has a tendency of flowing along a path of least resistance, as illustrated by air flow path 65 along an outer surface 63. In other words, the air flow path 65 represents a large radius of a turn of the air flow from the upstream air flow path 60, through the zone 70, toward the downstream air flow path 68. In contrast, a lesser amount of air flow passes through the zone 70 along a small radius of curvature near the front plate 48, as indicated by air flow path 67. The non-uniform flow between the large and small radius of turns (e.g., paths 65 and 67) causes non-uniform flow entering the inner annular flow passage 53 through the opening regions 64. In particular, the air flow may be greater along the hub 54 and lesser along the shroud 50 at the opening regions 64. The fuel nozzles 12 also may receive a non-uniform flow of air from the outer annular flow passage 45 due to different radial distances from the passage 45 to the inner annular flow passage 53 of various fuel nozzles 12. For example, a central fuel nozzle 78 is located at a greater radial distance from the passage 45 then outer fuel nozzles 76. Furthermore, each fuel nozzle 12 may receive more air flow radially closer to the passage 45 and less air flow radially further from the passage 45.

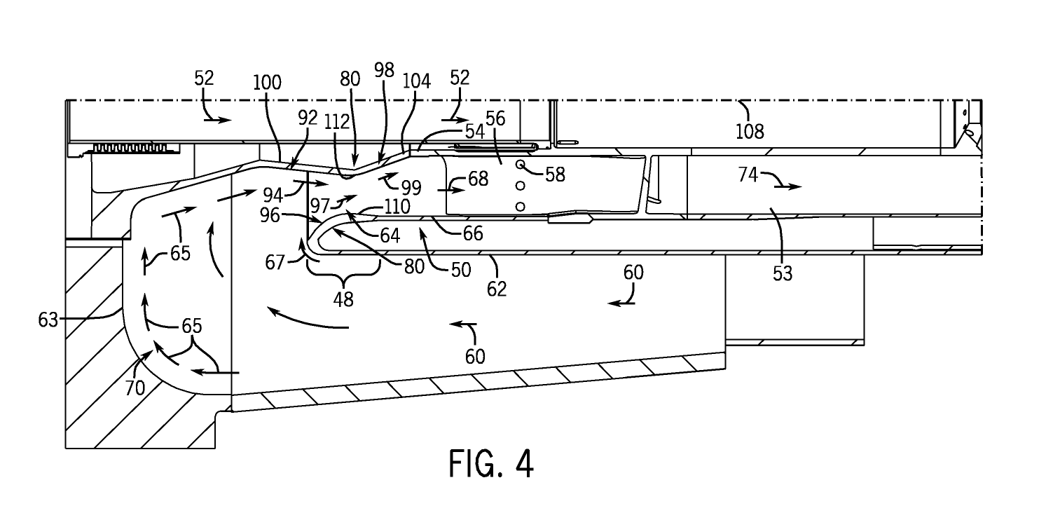

However, the fuel nozzle assembly 42 includes a design to substantially reduce or eliminate the flow deficit regions in the fuel nozzles 12, while smoothly turning the air flow and reducing pressure drops as illustrated in FIGS. 3-8. In particular, each fuel nozzle 12 of the fuel nozzle assembly 42 includes a flow guide 80 disposed along the air flow path 68 in the opening region 64 upstream of the plurality of swirl vanes 56 disposed between the hub 54 and the shroud 50. FIG. 4 is a cross-sectional side view of a portion of a single fuel nozzle 12 and surrounding region of the fuel nozzle assembly 42 in FIG. 3, further illustrating details of the flow guide 80. The fuel nozzle assembly 42 and fuel nozzle 12 are as described in FIG. 3. The flow guide 80 includes a guide portion 92, a guide portion 96, and a guide portion 98. As illustrated, the guide portions 92 are angled relative to an axis 108 of the fuel nozzle 12, such that the guide portions 92, 96, and 98 redistribute the air flow in the inner annular flow passage 53 to provide a more uniform flow profile between the hub 54 and the shroud 50.

In the illustrated embodiment, the guide portions 92 and 98 are disposed along the hub 54, while the guide portion 96 is disposed along the shroud 50. However, other embodiments may exclude or rearrange one of more of the guide portions 92, 96, and 98 on the hub 54 and the shroud 50. The guide portions 92 and 96 are disposed upstream from the guide portion 98. In particular, the guide portions 92 and 96 generally converge toward one another (e.g., converge the inner annular flow passage 53) near the opening region 64, thereby defining a converging flow section near the opening region 64. The guide portion 98 contrastingly diverges the inner annular flow passage 53, thereby defining a diverging flow section downstream of the guide portions 92 and 96. As a result, various embodiments of the flow guide 80 may be described as a converging-diverging section 81.

The guide portion 92 is configured to guide the air flow radially outward, as generally indicated by arrow 94, from the hub 54 toward the inner surface 66 of the shroud 50. The radial outward flow 94 provided by the guide portion 92 helps to redistribute the airflow (e.g., large radius airflow path 65) to increase the airflow along the shroud 50 and decrease the airflow along the hub 54, thereby improving uniformity of the airflow in the opening region 64. In particular, the guide portion 92 increases the axial airflow velocity along the shroud 50 and decreases the axial airflow velocity along the hub 54 to create a more uniform axial velocity profile in the passage 53 between the shroud 50 and the hub 54. As illustrated in FIGS. 3 and 4, the guide portion 92 includes an annular wall portion 100 that increases in diameter 102 in the downstream direction indicated by arrow 68. For example, the illustrated embodiment of the guide portion 92 has a conical wall portion 100 defined by a generally constant angle relative to the axis 108 of the fuel nozzle 12. However, certain embodiments of the guide portion 92 may have a curved wall portion 100 defined by a variable angle (e.g., curved profile) in a downstream direction along the axis 108. In either embodiment, the annular wall portion 100 generally diverges from the axis 108 in the downstream direction, thereby converging the passage 53 between the shroud 50 and the hub 54.

The guide portion 96 is configured to guide the air flow radially inward, as generally indicated by arrow 97, around the upstream end of the shroud 50 (e.g., front plate 48). In the illustrated embodiment, the guide portion 96 has a curved annular shape that gradually decreases in angle relative to the axis 108 in the downstream direction. Thus, the guide portion 96 is initially angled more toward the hub 54 at the upstream end portion of the shroud 50, and gradually becomes angled more in the downstream direction (e.g., parallel to the axis 108) toward a downstream end portion 110 of the guide portion 96. In certain embodiments, the guide portion 96 may have a conical shape defined by a generally constant angle relative to the axis 108. In either embodiment, the guide portion 96 generally converges toward the axis 108 and the hub 54 in the downstream direction, thereby converging the passage 53 between the shroud 50 and the hub 54. The guide portion 96 helps to gradually turn the airflow around the upstream end portion of the shroud 50, while also helping to redistribute some of the airflow radially inward toward the hub 54 as indicated by arrow 97. For example, as discussed in further detail below, the guide portion 96 may be angled and positioned to direct some of the airflow radially inward toward the hub 54 at least substantially downstream of the guide portion 92. In this manner, the guide portion 96 helps to improve uniformity of the airflow in the opening region 64. However, as illustrated in FIGS. 3 and 4, the guide portion 92 overlaps and extends axially beyond guide portion 96 to define an axial offset between the downstream end portion 110 of the guide portion 96 and a downstream end portion 112 of the guide portion 92. As discussed in further detail below, the guide portion 92 extends axially beyond the guide portion 96 to ensure that the radially outward flow 94 provided by the guide portion 92 dominates the radially inward flow 97 provided by the guide portion 96, thereby helping to increase the uniformity of the air flow profile in the passage 53.

The guide portion 98 is configured to guide the air flow radially inward, as generally indicated by arrow 99, from the shroud 50 toward the hub 54. The radial inward flow 99 provided by the guide portion 98 helps to redistribute the airflow to improve uniformity of the airflow (e.g., more uniform axial velocity profile) in the passage 53 between the shroud 50 and the hub 54. In particular, the guide portion 98 enables the airflow to expand downstream from the guide portions 92 and 96, and specifically flow toward the hub 54. As illustrated in FIGS. 3 and 4, the guide portion 98 includes an annular wall portion 104 that decreases in diameter 106 in the downstream direction indicated by arrow 68. For example, the illustrated embodiment of the guide portion 98 has a conical wall portion 104 defined by a generally constant angle relative to the axis 108 of the fuel nozzle 12. However, certain embodiments of the guide portion 98 may have a curved wall portion 104 defined by a variable angle (e.g., curved profile) in a downstream direction along the axis 108. In either embodiment, the annular wall portion 104 generally converges toward the axis 108 in the downstream direction, thereby diverging the passage 53 between the shroud 50 and the hub 54.

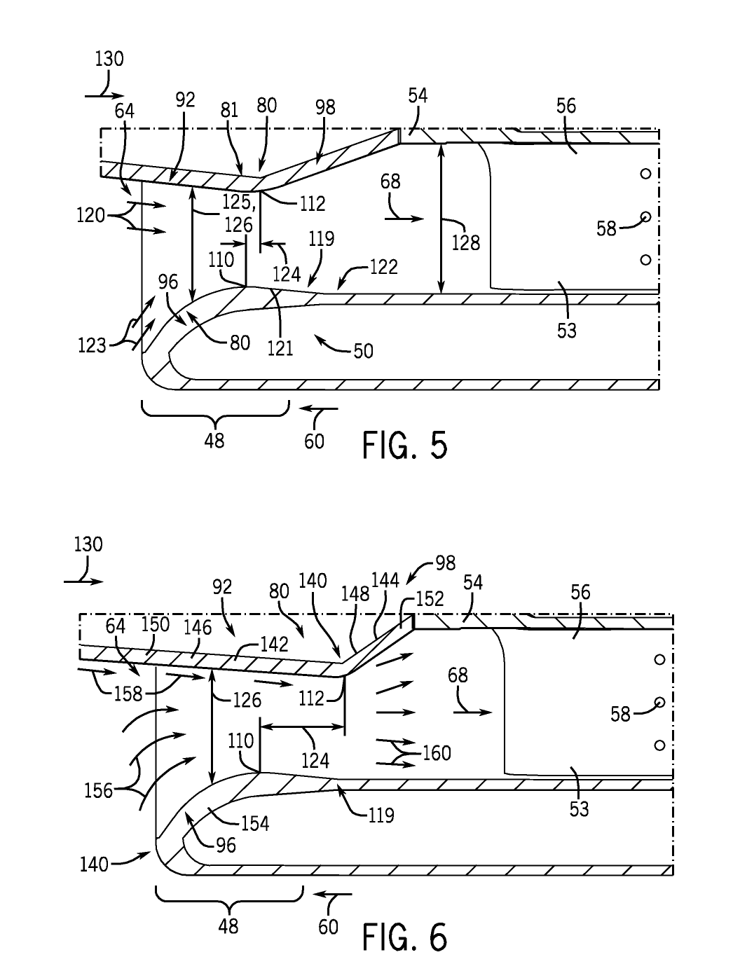

FIG. 5 is cross-sectional side view of an embodiment of the flow guide 80, illustrating details of the converging-diverging section 81 defined by the flow guides 92, 96, and 98. As described above, the flow guide 80 includes the guide portions 92, 96, and 98 to smoothly turn, guide, redistribute, and improve uniformity of the airflow through the opening region 64 of the fuel nozzle 12. For example, the guide portion 92 is angled radially outward from the hub 54 toward the shroud 50 to direct an air flow 120 toward an otherwise low velocity region 122 (e.g., along the shroud 50) adjacent a turn between the upstream air flow path 60 and the downstream air flow path 68. Without the flow guide 80, the region 122 has a flow deficit (e.g., low velocity or recirculation) that may be attributed to the 180 degree turn around the upstream end of the shroud 50 from the outer annular flow passage 45 (e.g., upstream flow path 60) to the inner annular flow passage 53 (e.g., downstream flow path 58). Thus, the flow deficit may lead to a possibility of flame holding at or near the region 122. In the illustrated embodiment, the guide portion 92 helps to reduce or eliminate the flow deficit in the otherwise low velocity region 122 by focusing airflow in the region 122, as indicated by airflow 120. The flow guide 80 also includes the guide portions 96 and 98 to help provide uniform airflow (e.g., uniform axial velocity) in radial and circumferential directions throughout the inner annular flow passage 53. For example, the guide portions 92 and 96 converge toward one another to define a converging section, which is followed by a diverging section defined by the guide portion 98. The converging-diverging section is configured to help increase the uniformity of the airflow upstream of the vanes 56. In particular, the guide portions 92 and 96 converge the airflow in a manner that forces the airflow to increase in velocity and redistribute more uniformly in the circumferential direction about the inner annular flow passage 53, while simultaneously forcing the increased air velocity toward the otherwise low velocity region 122. Subsequently, the guide portion 98 diverges the airflow in a manner that enables the airflow to decrease in velocity, while also radially distributing the airflow more uniformly between the shroud 50 and the hub 54.

As mentioned above, the downstream end portion 110 of the guide portion 96 and the downstream end portion 112 of the guide portion 92 are situated to define axial offset 124. The offset 124 may be selected to control the dominance of the guide portion 92 (e.g., outward airflow 120) relative to the guide portion 96 (e.g., inward airflow 123). For example, a greater offset 124 may be used to provide a greater dominance of the airflow 120 provided by the guide portion 92 toward the otherwise low velocity region 122. In contrast, a lesser offset 124 may be used to provide a greater dominance of an airflow 123 provided by the guide portion 96 toward the hub 54. In this manner, the offset 124 may be selected to provide a suitable balance of the outward airflow 120 and the inward airflow 123 to provide a substantially uniform airflow profile across the passage 53.

Along the offset 124, the flow guide 80 includes a guide portion 119 that generally diverges relative to the axis 108 of the fuel nozzle 12. In the illustrated embodiment, the guide portion 119 extends from the downstream end portion 110 of the guide portion 96, and extends partially along the guide portions 92 and 98. The guide portion 119 has an annular surface 121 that may be a variable angle annular surface (e.g., curved annular surface) or a constant angle annular surface (e.g., conical surface). In either embodiment, the annular surface 121 generally diverges from the hub 54 and the axis 108, thereby either maintaining or diverging a flow area of the inner annular flow passage 53 between the shroud 50 and the hub 54. For example, the annular surface 121 may be angled to maintain a substantially constant flow area between the guide portions 92 and 119, while diverging (or increasing) the flow area between the guide portions 98 and 119. As illustrated in FIG. 5, the annular surface 121 is angled outwardly toward the otherwise low velocity region 122, thereby helping to guide the airflow toward the region 122 to reduce the flow deficit. The guide portions 98 and 119 also may diverge from one another to help reduce the flow velocity and distribute the flow more uniformly upstream from the vanes 56.

As further illustrated in FIG. 5, an upstream cross-sectional area 125 in the opening region 64 is smaller than a downstream cross-sectional area 128 near the vanes 56. As discussed above, the guide portions 92 and 96 converge toward one another to reduce the upstream cross-sectional area 125, while the guide portions 98 and 119 diverge from one another to increase the downstream cross-sectional area 128. Despite the reduced upstream cross-sectional area 125, the flow guide 80 maintains a sufficient airflow by forcing airflow into the otherwise low velocity region 122. In other words, the flow guide 80 may be designed to maintain or increase the effective cross-sectional area (e.g., area actually flowing air) by uniformly distributing the airflow across the entire inner annular flow passage 53. In addition, the placement of the flow guide 80 and the reduced upstream cross-sectional area 125 upstream of the vanes 56 may not generate additional pressure losses. In certain embodiments, the area 125 may range from approximately 1 to 50, 1 to 25, or 5 to 20 percent less than the area 128.

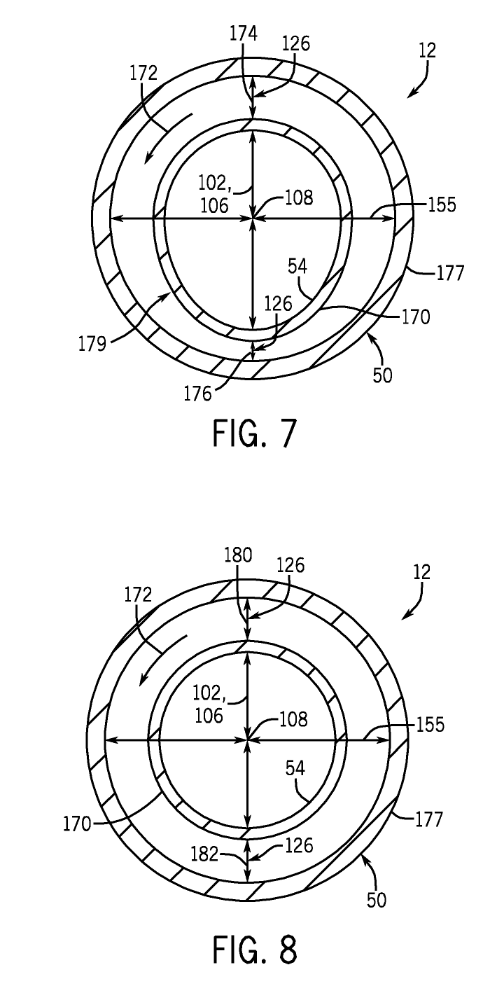

The flow guide 80 also provides a variable radial gap 126 within the opening region 64, e.g., between the hub 54 and the shroud 50. The variable radial gap 126 decreases and increases in an axial direction 130 along the axis 108 of the fuel nozzle 12. As discussed in further detail below with reference to FIG. 7, the variable radial gap 126 may also change in a circumferential direction around the axis 108. The variable gap 126 may be changed by approximately 1 to 100, to 50, or 1 to 25 percent in the axial direction 130. Furthermore, as discussed below, the variable radial gap 126 may change by approximately 1 to 100, 1 to 50, or 1 to 25 percent in the circumferential direction. The variable radial gap 126 may be selected to help distribute the airflow both radially and circumferentially in the inner annular flow passage 53.

FIG. 6 is a cross-sectional side view of an embodiment of the fuel nozzle 12 having the flow guide 80 with a converging-diverging section 140, wherein the section 140 has a greater offset 124 than the converging-diverging section 81 of FIG. 5. In the illustrated embodiment, the fuel nozzle 12 includes the hub 54, the plurality of vanes 56, and the shroud 50, as previously described. The opening region 64 between the hub 54 and the shroud 50 includes the converging-diverging section 140. The converging-diverging section 140 is disposed along the air flow path 68 upstream from the plurality of vanes 58 and the plurality of fuel ports 58. The converging-diverging section 140 includes a converging annular section 142 upstream from a diverging annular section 144. In certain embodiments, the converging annular section 142 includes a conical wall section 146 and the diverging annular section 144 includes a conical wall section 148. As illustrated, the conical wall section 146 is disposed along an annular wall section 150 of the hub 54, such that the hub 54 increases in diameter 102 (see FIG. 3) in the downstream direction along the air flow path 68. Similarly, the conical wall section 148 is disposed along an annular wall section 152 of the hub 54, such that the hub 54 decreases in diameter 106 (see FIG. 3) in the downstream direction along the air flow path 68. The converging-diverging section 140 also includes an annular wall section 154 along the shroud 50. The annular wall section 154 increases in diameter 155 (see FIG. 3) in the downstream direction along the air flow path 68 at least for a portion of the section 154. The annular wall section 154 extends circumferentially about the annular wall section 150.

As described above, the converging-diverging section 140 operates to smoothly turn, guide, redistribute, and improve uniformity of the airflow through the opening region 64 of the fuel nozzle 12. Particularly, turning air flow, generally indicated by arrows 156, encounters conical wall section 146 which is angled toward the shroud 50. The conical wall section 146 directs the turning air flow 156 radially outward from the hub 54 toward the shroud 50, as generally indicated by arrows 158. Annular wall section 154 is contoured to direct the turning air flow 156 to fill the space downstream of the conical wall section 148. The divergence of the conical wall section 148 enables expansion of the air flow, as generally indicated by arrows 160, in the downstream air flow path 68. The air flow 160 does not separate from the hub 54 and shroud 50 in the downstream air flow path 68. Thus, in conjunction with one another, the wall sections 146, 148, and 154 substantially reduce or eliminate any flow deficit (e.g., low velocity or recirculation region) along the shroud 50 in the opening region 64. In this manner, the wall sections 146, 148, and 154 substantially increase uniformity of the airflow in the axial direction 130 within the opening region 64 upstream of the vanes 54, thereby reducing the possibility of any flame holding.

Similar to the converging-diverging section 81 of FIG. 5, the converging-diverging section 140 of FIG. 6 includes the axial offset 124 defined by the conical wall section 146 overlapping and extending axially beyond the annular wall section 154. The axial offset 124 extends between downstream end portion 110 of annular wall section 154 and downstream end portion 112 of conical wall section 146. The illustrated offset 124 in FIG. 6 is greater than the offset 124 in FIG. 5. As discussed above, the offset 124 may be selected to control the dominance of the conical wall section 146 (e.g., outward airflow) relative to the annular wall section 154 (e.g., inward airflow). For example, a greater offset 124 may be used to provide a greater dominance of the airflow provided by the conical wall section 146 toward the otherwise low velocity region along the shroud 50. In the illustrated embodiment, the axial offset 124 of FIG. 6 may be approximately 1.5 to 20 times greater than the axial offset 124 of FIG. 5. In certain embodiments, the offset 124 may be based on the air flow rate, the angle of the conical wall sections 146 and 148, the angle or curvature of the annular wall section 154, the distance (e.g., variable radial gap 126) between the shroud 50 and the hub 54, and/or various other parameters. For example, the offset 124 may be a function of the variable radial gap 126 at the downstream end portion 110 of the annular wall section 154. In certain embodiments, the offset 124 may be approximately 0.1 to 5 or 0.2 to 2 times the variable radial gap 126 at the downstream end portion 110 of the annular wall section 154.

In addition to the offset 124, the flow guide 80 includes the variable radial gap 126 between the hub 54 and the shroud 50. As mentioned above, the variable radial gap 126 increases and decreases in the axial direction 130 along the axis 108 of the fuel nozzle 12. As illustrated in FIGS. 7 and 8, the variable radial gap 126 may remain the same or vary circumferentially about the fuel nozzle 12. FIGS. 7 and 8 are cross-sections taken along line 7-7 of FIG. 3 of the fuel nozzle 12. As illustrated, a circumference 170 may represent either guide portion 92 or guide portion 98 of the flow guide 80 of FIGS. 3-6. As illustrated in FIG. 7, the variable radial gap 126 increases and decreases in a circumferential direction 172 around the axis 108 of the fuel nozzle 12. For example, a length 174 of the variable radial gap 126 on one side of the fuel nozzle 12 is greater than a length 176 of the variable radial gap 126 on an opposite side of the fuel nozzle 12. The variable radial gap 126 may vary due to asymmetry about the circumference 170 of the fuel nozzle 12 or to asymmetry about a circumference 177 of the shroud 50. As illustrated, the circumference 170 is asymmetrical with a portion 179 (e.g. a 180 degree section) about the circumference 170 offset. Thus, the diameter 102 or 106 (see FIG. 3) may vary about circumference 170 of the fuel nozzle 12. Also, the diameter 155 may vary about the circumference 177 of the shroud 50. In addition to the variability in the variable radial gap 126 about circumferences 170 and 177, the axial offset 124 may also vary about the circumferences 170 and 177 between downstream end portions 110 and 112. In this manner, the variable radial gap 126 and the axial offset 124 may control the airflow to provide a more uniform airflow downstream of the flow guide 80. In particular, the variable radial gap 126 may be greater (e.g., length 174) further away from the outer annular passage 45 (see FIG. 3), while the variable radial gap 126 may be lesser (e.g., length 176) closer to the outer annular passage 45. In this manner, the variable radial gap 126 may route additional airflow to otherwise low flow regions in the fuel nozzle 12.

Alternatively, as illustrated in FIG. 8, the variable radial gap 126 remains the same in the circumferential direction 172 around the axis 108 of the fuel nozzle 12. For example, a length 180 of the variable radial gap 126 on one side of the fuel nozzle 12 is the same as a length 182 of the variable radial gap 126 on an opposite side of the fuel nozzle 12. Thus, the variable radial gap 126 remains the same due to symmetry about both circumferences 170 and 176 of the fuel nozzle 12 and the shroud 50, respectively. Therefore, the diameters 102, 106, and 155 remain the same about circumferences 170 and 176. The variable radial gap 126 and the axial offset 124, along with the other features of the flow guide 80, provide a more uniform flow in the downstream air flow path 68 in both radial and circumferential directions in the inner annular flow passage 53 of the fuel nozzle 12.

Technical effects of the disclosed embodiments include employing an improved air flow design in the fuel nozzle assembly 42. The improved flow design includes employing the flow guide 80 (e.g., converging-diverging sections 81 or 140) to redirect air flow to flow deficient regions. Redirecting the air flow results in uniform air flow in the axial direction both radially across and circumferentially about the fuel nozzle 12. The redirected air flow also results in reducing pressure losses while providing some axial velocity to all of the vane sectors to minimize the occurrence of flame-holding.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a turbine fuel nozzle, comprising:
a hub;
a plurality of vanes extending radially outward from the hub;
a shroud disposed about the hub and the plurality of vanes;
an air flow path extending between the hub and the shroud in a downstream direction toward an outlet region of the turbine fuel nozzle;
a fuel flow path extending to a plurality of fuel ports along the air flow path; and
a converging-diverging section disposed along the air flow path upstream from the plurality of vanes and the plurality of fuel ports.

2. The system of claim 1, wherein the converging-diverging section comprises a converging annular section upstream from a diverging annular section.

3. The system of claim 2, wherein the converging annular section comprises a first conical wall section and the diverging annular section comprises a second conical wall section.

4. The system of claim 1, wherein the converging-diverging section comprises a first annular wall section of the hub, and the first annular wall section increases in diameter in the downstream direction along the air flow path.

5. The system of claim 4, wherein the converging-diverging section comprises a second annular wall section of the hub, the second annular wall section decreases in diameter in the downstream direction along the air flow path, and the second annular wall section is downstream from the first annular wall section.

6. The system of claim 5, wherein the converging-diverging section comprises a third annular wall section of the shroud, and the third annular wall section increases in diameter in the downstream direction along the air flow path.

7. The system of claim 6, wherein the third annular wall section extends circumferentially about the first annular wall section.

8. The system of claim 7, wherein the first annular wall section overlaps and extends axially beyond the third annular wall section to define an axial offset between downstream end portions of the first and third annular wall sections.

9. The system of claim 1, wherein the converging-diverging section comprises a variable radial gap between the hub and the shroud, the variable radial gap increases and decreases in an axial direction along an axis of the turbine fuel nozzle, and the variable radial gap increases and decreases in a circumferential direction around the axis.

10. The system of claim 1, comprising a flow sleeve disposed about the shroud, wherein the air flow path extends between the flow sleeve and the shroud in an upstream direction toward an opening region between the shroud and the hub, and the air flow path extends between the hub and the shroud in the downstream direction from the opening region toward the outlet region.

11. The system of claim 10, wherein the opening region comprises the converging-diverging section.

12. The system of claim 1, comprising a gas turbine combustor or a gas turbine engine having the turbine fuel nozzle.

13. A system, comprising:
a fuel nozzle assembly, comprising:
a hub;
a shroud disposed about the hub;
a flow sleeve disposed about the shroud;
an air flow path extending between the flow sleeve and the shroud in an upstream direction toward an opening region between the shroud and the hub, wherein the air flow path extends between the hub and the shroud in a downstream direction from the opening region toward an outlet region of the fuel nozzle assembly;
a fuel flow path extending to at least one fuel port along the air flow path; and
a flow guide disposed along the air flow path in the opening region, wherein the flow guide comprises a first guide portion configured to guide an air flow radially outward from the hub toward the shroud.

14. The system of claim 13, wherein the first guide portion comprises a first annular wall portion that increases in diameter in the downstream direction.

15. The system of claim 14, wherein the flow guide comprises a second guide portion having a second annular wall portion that decreases in diameter in the downstream direction.

16. The system of claim 15, wherein the first and second guide portions are coupled to the hub.

17. The system of claim 14, wherein the first guide portion is coupled to the hub, the second guide portion is coupled to the shroud, and the first guide portion overlaps and extends axially beyond the second guide portion to define an axial offset between downstream end portions of the first and second guide portions.

18. The system of claim 13, wherein the flow guide comprises a variable radial gap between the hub and the shroud, the variable radial gap increases and decreases in an axial direction along an axis of the fuel nozzle assembly, and the variable radial gap increases and decreases in a circumferential direction around the axis.

19. A system, comprising:
a turbine engine;
a fuel nozzle assembly coupled to the turbine engine, wherein the fuel nozzle assembly comprises:
a flow sleeve comprising an upstream air flow path; and
a plurality of fuel nozzles disposed in the flow sleeve, wherein each fuel nozzle comprises a downstream air flow path, and a flow guide configured to direct an air flow toward a low velocity region adjacent a turn between the upstream air flow path and the downstream air flow path.

20. The system of claim 19, wherein each fuel nozzle comprises a hub, a shroud disposed about the hub, a plurality of swirl vanes disposed between the hub and the shroud, and a fuel flow path extending through the hub to at least one fuel port, wherein the downstream air flow path extends between the hub and the shroud, the upstream air flow path extends between the flow sleeve and the shroud, and a guide portion of the flow guide is angled radially outward from the hub toward the shroud.
